(19) United States
(12) Patent Application Publication
(10) Pub. No.: US 2008/0230749 A1
(43) Pub. Date: Sep. 25, 2008

(54) Adhesive Agent Composition and Adhesive Film For Electronic Component

(75) Inventors: Takahiro Matsuse, Tokyo (JP); Kentaro Hanzawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/569,265

(22) PCT Filed: May 19, 2005
(86) PCT No.: PCT/JP05/09136

§ 371 Date: Jun. 13, 2007

(30) Foreign Application Priority Data
May 19, 2004 (JP) 2004-149372
Dec. 13, 2004 (JP) 2004-360078
Dec. 13, 2004 (JP) 2004-360079

(51) Int. Cl. C08G 63/66

(52) U.S. Cl. 252/500; 525/451

(57) ABSTRACT

An adhesive agent composition for bonding an electronic component contains a polyester unsaturated compound having a number average molecular weight of 2,000-6,000. The electronic component is bonded by using a film produced by forming the composition into a film.

### CROSS REFERENCE TO RELATED APPLICATION

This is a continuation application of PCT/JP2005/009136 filed on May 19, 2005.

### TECHNICAL FIELD

The present invention relates to an adhesive agent composition used for bonding an electronic component, and an adhesive film produced by forming the adhesive agent composition into a film.

### Background Art

An ACF (Anisotropic Conductive Film) is used to bond various kinds of circuit boards to each other while ensuring electrical conduction between circuits, for example, when a flexible printed circuit (FPC) board or a TAB chip is connected to ITO (Indium Tin Oxide) terminals formed on a glass substrate of a liquid crystal panel.

Japanese Unexamined Patent Application Publication No. 2003-20464 and No. 2001-202831 disclose ACFs in which conductive particles are dispersed in a thermo- or photo-setting adhesive agent containing a polyester unsaturated compound as a main ingredient.

The conductive particles mixed in the ACFs are made of metal particles or plastic particles plated with a metal, and they are expensive.

An NCF (Non Conductive Film) containing no conductive particles is also used. However, the known NCF exhibits insufficient flowability when it is heated and softened.

### SUMMARY OF THE INVENTION

According to first and second aspects, an object of the present invention is to provide an adhesive agent composition and an adhesive film, which have superior adhesivity and flowability.

The adhesive agent composition for bonding an electronic component, according to the first aspect, contains a thermosetting compound, and the thermosetting compound is a polyester unsaturated compound having a number average molecular weight of 2,000-6,000.

The adhesive film according to the second aspect is produced by forming the adhesive agent composition according to the first aspect into a film.

According to third and fourth aspects, an object of the present invention is to provide an adhesive agent composition and an adhesive film, which ensures superior durability of an adhesion force against heat and against wet heat, and which can maintain a high adhesion force for a long period even under high-temperature or high-temperature and high-humidity environments.

The adhesive agent composition for bonding the electronic component, according to the third aspect, contains, in addition to a thermosetting resin, a multifunctional glycidyl monomer.

The adhesive film according to the fourth aspect is produced by forming the adhesive agent composition according to the third aspect into a film.

### DETAILED DESCRIPTION OF PREFERRED EMBODIMENTS

### Preferred Embodiments of First and Second Aspects

The adhesive agent composition according to the first aspect contains a polyester unsaturated compound having a number average molecular weight of 2,000-6,000.

The low-molecular-weight polyester unsaturated compound having a number average molecular weight of 2,000-6,000 gives good flowability to a film. A thermosetting adhesive agent containing such a polyester unsaturated compound as a main ingredient has advantages given below.
1) It has superior resistance against heat and moisture and effectively exhibits ACF characteristics even after being held under high temperature and high humidity for a long time. Thus, its durability is excellent.
2) It has good repairability.
3) As compared with known adhesive agents, it exhibits higher adhesivity with stability. In particular, it exhibits high adhesivity with respect to polyimide on a non-electrode surface of a 2-layered flexible printed circuit board of non-adhesive type for which the known adhesive agents have a difficulty in bonding thereto.
4) While known epoxy adhesive agents require heating to 150° or above, an ACF using the adhesive agent according to the first aspect enables hardening and bonding to be made 130° C. or below, particularly 100° C. or below.
5) Stickiness of the known epoxy- or phenol-based ACFs is so weak that temporary fixing of the films to an electrode is difficult to achieve with tack strength and the films are apt to peel off, thus resulting in poor workability. In contrast, the ACF using the adhesive agent according to the first aspect can provide a high adhesive force for temporary fixing of the film and ensure good workability.

The adhesive film according to the second aspect, which is produced by forming the adhesive agent composition according to first aspect into a film, has superior adhesivity and flowability. The adhesive film is able to sufficiently flow between complicated and fine bumps to such an extent as establishing connection and conduction between circuits with sufficient reliability. Further, the adhesive film is able to firmly bond circuit boards to each other.

The polyester unsaturated compound may be unsaturated polyester which is obtained by reacting a polybasic acid and a polyhydric alcohol with each other, or may be a compound obtained by introducing a (metha)acryloxy group into saturated copolymer polyester that is dissolved in a solvent. The (metha)acryloxy group is an acryloxy group and/or a metha-acryloxy group.

The polyester unsaturated compound is dissoluble in an organic solvent, such as acetone, MEK, ethyl acetate, cellosolve acetate, dioxane, THF, benzene, toluene, xylene, cyclohexane, and Solvesso 100.

The saturated copolymer polyester dissoluble in the solvent is obtained by copolymerization of acid and alcohol. The acid preferably contains a terephthalic acid as a main ingredient. Further, the acid contains a phthalic acid, an isophthalic acid, an adipic acid, a sebacic acid, a dodecane acid, etc. in amount of 5-50 mol % with respect to the total acid. The alcohol preferably contains ethylene glycol and/or 1,4-butanediol. Further, the alcohol contains at least one kind of 1,3-propanediol, 2,2-dimethyl-1,3-propanedioal, 2,2-diethyl-1,3-propanediol, 2-ethyl-2-butyl-1,3-propanediol, 1,6-hexanediol, 1,9-nonanediol, etc. in amount of 5-50 mol % with respect to the total alcohol.

The (metha)acryloxy group is introduced into the saturated copolymer polyester by the following method (1), (2) or (3).
(1) A method of reacting isocyanatealkyl(metha)acrylate with a hydroxyl group of the saturated copolymer polyester.
(2) A method of utilizing an ester interchange reaction between alkyl(metha)acrylate and a hydroxyl group of the saturated copolymer polyester.
(3) A method of reacting isocyanatealkyl(metha)acrylate, which is obtained by a reaction between a diisocyanate compound and hydroxyalkyl(metha)acrylate, with a hydroxyl group of the saturated copolymer polyester.

The polyester unsaturated compound has a number average molecular weight of 2,000-6,000, preferably 3,000-5,000. A compound having a number average molecular weight of larger than 6,000 does not provide sufficient flowability, whereas a compound having a number average molecular weight of smaller than 2,000 does not provide sufficient adhesivity.

The polyester unsaturated compound obtained by introducing the (metha)acryloxy group into the saturated copolymer polyester is preferably produced by introducing the (metha)acryloxy group into the saturated copolymer polyester having a number average molecular weight of about 2,000-6,000.

The polyester unsaturated compound having the number average molecular weight within the above-mentioned range and the polyester unsaturated compound having the number average molecular weight outside the above-mentioned range may be blended with each other.

For the purpose of increasing durability against heat and against wet heat, the adhesive agent composition may contain a multifunctional glycidyl monomer. The multifunctional glycidyl monomer is a monomer compound having two or more glycidyl groups in a molecule in average.

The compound having two glycidyl groups in a molecule in average may be, for example, polyethyleneglycol-diglycidyl ether, polypropyleneglycol-diglycidyl ether, tetramethyleneglycol-diglycidyl ether, 1,6-hexamethyleneglycol-diglycidyl ether, neopentylglycol-diglycidyl ether, or glycerin-diglycidyl ether, which belong to the aliphatic series; hydrogenated bisphenol A•diglycidyl ether, hydrogenated isophthalic acid diglycidyl ester, 3,4-epoxy•cyclohexyl•methyl-3,4-epoxy cyclohexane carboxylate, or bis(3,4-epoxy•cyclohexyl)adipate, which belong to the alicyclic series; or diglycidyl•hydantoin, diglycidyl•oxyalkyl•hydantoin, which belong to the heterocyclic series; or bisphenol A•diglycidyl ether, an initial condensation product of bisphenol A•diglycidyl ether, diphenylmethane diglycidyl ether, terephthalic acid diglycidyl ester, isophthalic acid diglycidyl ester, or diglycidyl•aniline, which belong to the aromatic series.

The compound having three glycidyl groups in a molecule in average may be, for example, trimethylolpropane•triglycidyl ether which belongs to the aliphatic series; triglycidyl isocyanurate, triglycidyl cyanurate, or triglycidyl•hydantoin, which belong to the heterocyclic series; or triglycidyl-para- or meta-aminophenol which belongs to the aromatic series.

The compound having four glycidyl groups in a molecule in average may be, for example, tetraglycidyl•benzylethane, sorbitol•tetraglycidyl ether, tetraglycidyl•diaminophenylmethane, or tetraglycidyl•bisaminomethylcyclohexane.

The multifunctional glycidyl monomer is preferably at least one kind of multifunctional glycidyl ether compound. It may be, for example, ethyleneglycol•diglycidyl ether or trimethylolpropane•triglycidyl ether. Most preferably, it is trimethylolpropane•triglycidyl ether.

The amount of the mixed multifunctional glycidyl monomer is preferably 0.1-20 weight parts, more preferably 1-10 weight parts, with respect to 100 weight parts of the polyester unsaturated compound.

The adhesive film containing, as a main ingredient, the low-molecular-weight polyester unsaturated compound having a number average molecular weight of 2,000-6,000 and also containing the multifunctional glycidyl monomer maintains a high adhesion force for a long period even under conditions requiring resistance against heat and resistance against wet heat.

The detailed action mechanism which provides the effect of increasing the durability of a adhesive force against heat and against wet heat with mixing of the multifunctional glycidyl monomer is not clarified. It is however deemed that the durability of a layer of the thermosetting adhesive agent against heat and against wet heat is increased by creation of chemical bonding based on an addition reaction between a glycydyl group and an amide group, or an insertion reaction between them, or both of those reactions.

At least one kind of reactive compound (monomer) having an acryloxy group, a methacryloxy group, or an epoxy group is preferably mixed in the adhesive agent composition for the purpose of improving or adjusting physical properties (such as mechanical strength, adhesivity, optical characteristics, heat resistance, moisture resistance, weatherability, and cross-linking rate) of the adhesive film. The reactive compound may be a derivative of an acrylic acid or a methacrylic acid, e.g., any of esters and amides thereof. The ester residue may be, for example, not only an alkyl group such as a methyl, ethyl, dodecyl, stearyl, or layryl group, but also a cyclohexyl group, a tetrahydrofurfuryl group, an aminoethyl group, a 2-hydroxyethyl group, a 3-hydroxypropyl group, or a 3-chloro-2-hydroxypropyl group. The reactive compound may be ester in combination with a multifunctional alcohol, such as ethylene glycol, triethylene glycol, polypropylene glycol, polyethylene glycol, trimethylol propane, or pentaerythritol. The amide may be diacetone acrylamide.

A multifunctional cross-linking aid may be ester of an acrylic acid or a methacrylic acid, such as trimethylol propane, pentaerythritol, or glycerine. The compound containing the epoxy group may be triglycidyl tris(2-hydroxyethyl)isocyanurate, neopentyl glycol diglycidyl ether, 1,6-hexandiol diglycidyl ether, allyl glycidyl ether, 2-ethylhexyl glycidyl ether, phenyl glycidyl ether, phenol(EO)₅ glycidyl ether, p-t-butylphenyl glycidyl ether, adipic acid diglycidyl ester, phthalic acid diglycidyl ester, glycidyl methacrylate, or butyl glycidyl ether. The compound containing the epoxy group may be a polymer alloy containing the epoxy group.

The reactive compound is added in amount of preferably 0.5-80 weight parts, more preferably 0.5-70 weight parts, with respect to 100 weight parts of the polyester unsaturated compound. If the mixed amount exceeds 80 weight parts, workability and film formation performance in the stage of preparing the adhesive agent may be reduced.

The adhesive agent composition contains an organic peroxide as a hardener. The organic peroxide is preferably decomposed at temperature of 70° C. or above to generate a radical. More preferably, the decomposition temperature of the organic peroxide at a half-life of 10 hours is 50° or above.

The organic peroxide may be at least one kind of 2,5-dimethylhexane-2,5-dihydroperoxide, 2,5-dimethyl-2,5-di(t-butylperoxy)hexine3, di-t-butylperoxide, t-butylcumylperoxide, 2,5-dimethyl-2,5-di(t-butylperoxy)hexane, dicumylperoxide, α,α′-bis(t-butylperoxyisopropyl)benzene, n-butyl-4,4′-bis(t-butylperoxy)valerate, 1,1-bis(t-butylperoxy)cyclohexane, 1,1-bis(t-butylperoxy)-3,3,5-trimethylcyclohexane, t-butyl peroxybenzoate, benzoyl peroxide, t-butylperoxy acetate, methyl ethyl ketone peroxide, 2,5-dimethylhexyl-2,5-bisperoxybenzoate, butyl hydroperoxide, p-menthane hydroperoxide, p-chlorobenzoyl peroxide, hydroxyheptyl peroxide, chlorohexanone peroxide, octanoyl peroxide, decanoyl peroxide, rauloyl peroxide, cumylperoxyoctoate, succinic acid peroxide, acetyl peroxide, t-butylperoxy(2-ethylhexanoate), m-toluoyl peroxide, t-butylperoxyisobutylate, and 2,4-dichlorobenzoyl peroxide.

The organic peroxide is mixed in amount of preferably 0.1-10 weight parts with respect to 100 weight parts of the polyester unsaturated compound.

By controlling the amount of the mixed organic peroxide, the reaction start temperature (hardening start temperature) of the composition can be controlled. For example, by reducing the amount of the mixed organic peroxide in the adhesive film, the reaction start temperature of the composition can be delayed in reaching a predetermined level, and flowability of the composition at the start of the reaction can be improved eventually.

The adhesive agent composition may contain a silane coupling agent as an adhesion accelerator. The silane coupling agent may be at least one kind of vinyltriethoxysilane, vinyltris(β-methoxyethoxy)silane, γ-methacryloxypropyltrimethoxysilane, vinyltriacetoxysilane, γ-glycidoxypropyltrimethoxysilane, γ-glycidoxypropyltriethoxysilane, β-(3,4-epoxycyclohexyl)ethyltrimethoxysilane, vinyltrichlorosilane, γ-mercaptopropyltrimethoxysilane, γ-aminopropyltriethoxysilane, and N-β-(aminoethyl)-γ-aminopropyltrimethoxysilane.

The amount of the added silane coupling agent is preferably 0.01-5 weight parts with respect to 100 weight parts of the polyester unsaturated compound.

The adhesive agent composition may contain a hydrocarbon resin for the purpose of improving workability, sticking properties, etc. The hydrocarbon resin may be any of natural resins and synthetic resins. As the natural resins, rosin, a rosin derivative, and a terpen-based resin are preferably used. Practicable examples of the rosin include a gum-based resin, a tall oil-based resin, and a woody resin. Practicable examples of the rosin derivative are obtained by hydrogenating, de-homogenizing, polymerizing, esterifying, or metal-chloridizing the rosin. The terpen resin may be any of terpen-based resins such as α-pinene and β-pinene, or a terpen phenol resin. Other examples of the natural resins include dammar, copal, and shellac. As the synthetic resins, petroleum-based resins, phenol-based resins, and xylene-based resins are preferably used. Practicable examples of the petroleum-based resins include aliphatic petroleum resins, aromatic petroleum resins, alicyclic petroleum resins, copolymeric petroleum resins, hydrogenated petroleum resins, pure monomeric petroleum resins, and a coumarone-indene resin. Practicable examples of the phenol-based resins include an alkylphenol resin and a modified phenol resin. Practicable examples of the xylene-based resins include a xylene resin and a modified xylene resin.

The amount of the added hydrocarbon resin is preferably 1-200 weight parts, more preferably 1-100 weight parts, with respect to 100 weight parts of the polyester unsaturated compound.

The adhesive agent composition may contain an antiaging agent, an ultraviolet absorber, a dye, a working aid, etc.

The adhesive agent composition preferably has flowability of not larger than 1000 Pa·s, particularly in the range of 50-800 Pa·s, in terms of viscosity at the reaction start temperature when shearing viscoelasticity is measured by using parallel plates.

The adhesive film is produced through the steps of kneading the adhesive agent composition by an extruder, rolls, etc., and then forming it into a film with a predetermined shape by a film formation method utilizing a calender roll, T-die extrusion, or inflation. The adhesive film may also be formed through the steps of dissolving or dispersing the adhesive agent composition in a solvent, coating the solution over the surface of a separator, and evaporating the solvent. The film may be embossed, for example, in order to prevent blocking and to facilitate press-bonding to a bonding target.

The adhesive film can be stuck to the bonding target by a sticking method using a heat press, a direct lamination method using an extruder or a calender, a thermal press bonding method using a film laminator.

The bonding can also be performed through the steps of uniformly dissolving various component ingredients in a solvent, uniformly coating the solution over the surface of a separator, temporarily press-bonding other bonding target (such as polyimide or a copper foil) to the coated solution, and thermally hardening it.

Usually, the adhesive agent is hardened preferably at 70-170° C., more preferably at 70-150° C., for a period of preferably 10 seconds-120 minutes, more preferably 20 seconds-60 minutes.

A pressing force applied in the bonding step is preferably 1-4 MPa, more preferably 2-3 MPa.

When the adhesive film contains conductive particles, film conductivity is preferably not larger than 10Ω, more preferably not larger than 5Ω, in the direction of film thickness, and film resistance in the plane direction is preferably not smaller than 10⁶Ω, more preferably not smaller than 10⁹Ω.

The adhesive film formed from the adhesive agent composition is used to connect various kinds of terminals to each other, for example, when an FPC board or a TAB chip is connected to ITO terminals formed on a glass substrate of a liquid crystal panel, and when metal electrodes on FPC boards are connected to each other.

The adhesive agent composition may contain conductive particles. The conductive particles may be, for example, powder of a metal or an alloy including copper, silver, nickel, etc., or resin or ceramic powder coated with such a metal or alloy. The particles may have any desired shape including scale-like, dendritic, granular, and pellet-like shapes.

The conductive particles preferably have the elastic modulus of 1.0×10⁷-1.0×10¹⁰ Pa. The adhesive film containing the conductive particles, which has the elastic modulus in such a range, is able to suppress springback after the bonding. The conductive particles are preferably formed of synthetic resin particles of which surfaces are coated with the above-mentioned metal or alloy. [0052] The amount of the mixed conductive particles is preferably 0.1-15 volume % of the adhesive agent composition. The average particle size of the conductive particles is preferably 0.1-100 μm.

### EXAMPLES ACCORDING TO FIRST AND SECOND ASPECTS AND COMPARATIVE EXAMPLES

### Examples 1, 2 and Comparative Examples 1, 2

### Examples of Bonding Using Non-Conductive Films

Polyester resins shown in Table 1 were each dissolved in a mixed solvent of toluene and methyl ethyl ketone to prepare a solution of 40 weight %. Other ingredients shown in Table 1 were mixed in amounts, shown in Table 1, with respect to 100 weight parts of each polyester resin. The mixture was coated over a separator made of ethylene polyterephthalate by using a bar coater, whereby a film with a width of 2 mm and a thickness of 20 μm was obtained.

The obtained film was disposed between a 2-layered flexible printed circuit board of non-adhesive type and a transparent electrode glass, and after peeling off the separator, the film was properly positioned by using a monitor. Then, the substrate and the glass were subjected to thermal press bonding at 130° C. and 2 MPa for 30 seconds, whereby a sample was obtained.

The obtained sample was measured for an adhesion force by a 90°-peeling test (50 mm/min) using a tensile tester and was also measured for connection resistance by a digital multi-meter. The measured results are shown in Table 1.

The adhesive agent composition used in the adhesive film was measured for viscosity at the reaction start temperature by measuring shearing viscoelasticity with parallel plates (using ThermoHakke RheoStress 300, frequency: 1 Hz, displacement: 1.0%, temperature rise rate: 6° C./min). The measured results are also shown in Table 1.

TABLE 1

| | | | | | Comparative | |
|---|---|---|---|---|---|---|
| | | | Example | | Example | |
| | | | 1 | 2 | 1 | 2 |
| Mixing proportion | Polyester | Mixed amount (kind) | 100 (*1) | 100 (*2) | 100 (*3) | 100 (*4) |
| (weight part) | unsaturated | Number average molecular | 5000 | 3000 | 12000 | 1000 |
| | compound | weight | | | | |

| | | | | |
|---|---|---|---|---|
| Organic peroxide *5 | 2 | 2 | 2 | 2 |
| Compound containing acryloxy | 5 | 5 | 5 | 5 |
| group *6 | | | | |
| Compound containing | 3 | 3 | 3 | 3 |
| methacryloxy group *7 | | | | |
| Hydrocarbon resin *8 | 3 | 3 | 3 | 3 |
| Silane coupling agent *9 | 0.5 | 0.5 | 0.5 | 0.5 |

| Viscosity of adhesive agent composition at | | 900 | 500 | 2000 | 50 |
|---|---|---|---|---|---|
| reaction start time (Pa · s) | | | | | |
| Evaluation of non- | Adhesion force (gf/cm) | 500 | 550 | 550 | 100 |
| conductive | Connection resistance (Ω) | 5 | 4 | 100 | 3 |
| adhesive film | | | | | |

*1: decomposition compound of saturated copolymer polyester “elitel UE3600”, made by Unitika Ltd., into which is introduced methacryloxy group
*2: decomposition compound of “elitel UE3600” into which is introduced methacryloxy group
*3: compound of “elitel UE3600”, into which is introduced methacryloxy group
*4: decomposition compound of “elitel UE3600” into which is introduced methacryloxy group
*5: benzoylperoxide
*6: pentaeryethtol tetraacrylate
*7: neopentylglycol dimethacrylate
*8: hydrocarbon resin “ARKON P70” made by Arakawa Chemical Industries Ltd.
*9: γ-methacryloxypropyltrimethoxysilane

As seen from the results of Table 1, the non-conductive adhesive films each using the polyester unsaturated compound having a number average molecular weight of 2,000-6,000 can firmly bond the circuit substrates to each other with good conductivity because of its superior flowability and adhesivity. On the other hand, Comparative Example 1 using a polyester unsaturated compound having a high molecular molecular weight, i.e., a number average molecular weight of 12000, has good adhesivity, but it has poor flowability. Therefore, Comparative Example 1 cannot provide sufficient conductivity. Conversely, Comparative Example 2 using a polyester unsaturated compound having a very low molecular weight, i.e., a number average molecular weight of 1000, has good conductivity, but it has poor adhesivity.

The number average molecular weight was measured by GPC using a polystyrene calibration curve. This point is similarly applied to Examples and Comparative Examples described below.

### Examples 3, 4 and Comparative Examples 3, 4

### Examples of Bonding Using Conductive Films

Polyester resins shown in Table 2 were each dissolved in a mixed solvent of toluene and methyl ethyl ketone to prepare a solution of 35 weight %. Other ingredients shown in Table 2 were mixed in amounts, shown in Table 2, with respect to 100 weight parts of each polyester resin. The mixture was coated over a separator made of ethylene polyterephthalate by using a bar coater, whereby a film with a width of 2 mm and a thickness of 25 μm was obtained.

The obtained film was disposed between a 3-layered flexible printed circuit board and a transparent electrode glass, and after peeling off the separator, the film was properly positioned by using a monitor. Then, the substrate and the glass were subjected to thermal press bonding at 170° C. and 2 MPa for 15 seconds, whereby a sample was obtained.

The obtained sample was measured for an adhesion force by a 90°-peeling test (50 mm/min) using a tensile tester and was also measured for connection resistance by a digital multi-meter. The measured results are shown in Table 2.

The adhesive agent composition used in the adhesive film was measured for viscosity at the reaction start temperature by measuring shearing viscoelasticity with parallel plates (using ThermoHakke RheoStress 300, frequency: 1 Hz, displacement: 1.0%, temperature rise rate: 6° C./min). The measured results are also shown in Table 2.

TABLE 2

| | | | | | Comparative | |
|---|---|---|---|---|---|---|
| | | | Example | | Example | |
| | | | 3 | 4 | 3 | 4 |
| Mixing proportion | Polyester | Mixed amount (kind) | 100 (*1) | 100 (*2) | 100 (*3) | 100 (*4) |
| (weight part) | unsaturated | Number average molecular | 5000 | 4000 | 12000 | 1000 |
| | compound | weight | | | | |

| | | | | |
|---|---|---|---|---|
| Organic peroxide *5 | 1.5 | 1.5 | 1.5 | 1.5 |
| Compound containing acryloxy | 5 | 5 | 5 | 5 |
| group *6 | | | | |
| Compound containing | 3 | 3 | 3 | 3 |
| methacryloxy group *7 | | | | |
| Hydrocarbon resin *8 | 1 | 1 | 1 | 1 |
| Silane coupling agent *9 | 1 | 1 | 1 | 1 |
| Conductive particle *10 | 4 | 4 | 4 | 4 |

| Viscosity of adhesive agent composition at | | 1200 | 1100 | 3000 | 150 |
|---|---|---|---|---|---|
| reaction start time (Pa · s) | | | | | |
| Evaluation of non- | Adhesion force (gf/cm) | 800 | 900 | 850 | 300 |
| conductive | Connection resistance (Ω) | 2 | 1.5 | 20 | 1 |
| adhesive film | | | | | |

*1: decomposition compound of saturated copolymer polyester “elitel UE3600”, made by Unitika Ltd., into which is introduced methacryloxy group
*2: decomposition compound of “elitel UE3600” into which is introduced methacryloxy group
*3: compound of “elitel UE3600”, into which is introduced methacryloxy group
*4: decomposition compound of “elitel UE3600” into which is introduced methacryloxy group
*5: benzoylperoxide
*6: pentaeryethtol tetraacrylate
*7: neopentylglycol dimethacrylate
*8: hydrocarbon resin “ARKON P70” made by Arakawa Chemical Industries Ltd.
*9: γ-methacryloxypropyltrimethoxysilane
*10: gold-plated plastic particles with average particle size of 5 μm, and mixed amount is in terms of volume % with respect to thermosetting resin

As seen from the results of Table 2, the adhesive film using the polyester unsaturated compound having a number average molecular weight of 2,000-6,000 can firmly bond the circuit substrates to each other with good conductivity. On the other hand, Comparative Example 3 using a polyester unsaturated compound having a high molecular molecular weight, i.e., a number average molecular weight of 12000, has good adhesivity, but it has poor flowability. Therefore, Comparative Example 3 cannot provide sufficient contact of the mixed conductive particles with the circuit and eventually cannot provide sufficient conductivity. Conversely, Comparative Example 4 using a polyester unsaturated compound having a very low molecular weight, i.e., a number average molecular weight of 1000, has good conductivity, but it has poor adhesivity.

### Examples 5-8 and Comparative Example 5

### Examples of Bonding Using Non-Conductive Films

Polyester resins shown in Table 3 were each dissolved in a mixed solvent of toluene and methyl ethyl ketone to prepare a solution of 40 weight %. Other ingredients shown in Table 3 were mixed in amounts, shown in Table 3, with respect to 100 weight parts of each polyester resin. The mixture was coated over a film of ethylene polyterephthalate, which serves as a separator, by using a bar coater, whereby a film with a width of 2 mm and a thickness of 20 μm was obtained.

After peeling off the separator, the obtained film was properly positioned by using a monitor for bonding between a glass substrate and a polyimide substrate. Then, both the substrates were subjected to thermal press bonding at 170° C. and 2 MPa for 15 seconds.

A thus-obtained sample was measured for an adhesion force by a 90°-peeling test (50 mm/min) using a tensile tester immediately after the thermal press bonding (initial), after leaving the sample to stand under an ordinary condition (room temperature) for 24 hours, after leaving the sample to stand under a high-temperature condition (85° C.) for 24 hours, and after leaving the sample to stand under a high-temperature and high-humidity condition (60% and 95% RH) for 24 hours. The measured results are shown in Table 3.

TABLE 3

| | | | Example | | | | Comparative |
|---|---|---|---|---|---|---|---|
| | | | 5 | 6 | 7 | 8 | Example 5 |
| Mixing proportion | Polyester unsaturated compound *1 | | 100 | 100 | 100 | 100 | 100 |
| (weight part) | Multifunctional | ethyleneglycol•diglycidyl | 1 | 10 | — | — | — |
| | glycidyl monomer | ether *2 | | | | | |
| | | trimethylolpropane•triglycidyl | — | — | 1 | 10 | — |
| | | ether *3 | | | | | |

| | | | | | |
|---|---|---|---|---|---|
| Organic peroxide *4 | 2 | 2 | 2 | 2 | 2 |
| Compound containing acryloxy group *5 | 5 | 5 | 5 | 5 | 5 |
| Compound containing methacryloxy | 3 | 3 | 3 | 3 | 3 |
| group *6 | | | | | |
| Hydrocarbon resin *7 | 3 | 3 | 3 | 3 | 3 |
| Silane coupling agent *8 | 0.5 | 0.5 | 0.5 | 0.5 | 0.5 |

| | | | | | | |
|---|---|---|---|---|---|---|
| Adhesion force of non- | Initial | 880 | 880 | 880 | 880 | 880 |
| conductive film (gf/cm) | Ordinary condition (room | 801 | 814 | 777 | 789 | 800 |
| | temperature × 24 hr) | | | | | |
| | Heat resistance | 499 | 717 | 454 | 727 | 307 |
| | (85° C. × 24 hr) | | | | | |
| | Wet heat resistance | 551 | 609 | 574 | 689 | 418 |
| | (60° C., 95% RH × 24 hr) | | | | | |

*1: decomposition compound of saturated copolymer polyester “elitel UE3600”, made by Unitika Ltd., into which is introduced methacryloxy group (number average molecular weight of 3000)
*2: “40E” made by Kyoeisha Chemical Co., Ltd.
*3: “100MF” made by Kyoeisha Chemical Co., Ltd.
*4: benzoylperoxide
*5: pentaeryethtol tetraacrylate
*6: neopentylglycol dimethacrylate
*7: hydrocarbon resin “ARKON P70” made by Arakawa Chemical Industries Ltd.
*8: γ-methacryloxypropyltrimethoxysilane

As seen from the results of Table 3, the non-conductive adhesive film using the low-molecular-weight polyester unsaturated compound having a number average molecular weight of 2,000-6,000 has no serious problem with durability of an adhesion force at room temperature, but it has poor durability against heat and against wet heat. On the other hand, the non-conductive adhesive film prepared by mixing the multifunctional glycidyl monomer in the low-molecular-weight polyester unsaturated compound has superior durability of an adhesion force against heat and against wet heat.

### Examples 9-12 and Comparative Example 6

### Examples of Bonding Using Conductive Films

Polyester resins shown in Table 4 were each dissolved in a mixed solvent of toluene and methyl ethyl ketone to prepare a solution of 35 weight %. Other ingredients shown in Table 4 were mixed in amounts, shown in Table 1, with respect to 100 weight parts of each polyester resin. The mixture was coated over a film of ethylene polyterephthalate, which serves as a separator, by using a bar coater, whereby a film with a width of 2 mm and a thickness of 30 μm was obtained.

After peeling off the separator, the obtained film was properly positioned by using a monitor for bonding between a two-layered flexible printed circuit board of non-adhesive type and a transparent electrode glass. Then, the board and the glass were subjected to thermal press bonding at 170° C. and 2 MPa for 15 seconds.

A thus-obtained sample was measured for an adhesion force by a 90°-peeling test (50 mm/min) using a tensile tester immediately after the thermal press bonding (initial), after leaving the sample to stand under an ordinary condition (room temperature) for 24 hours, after leaving the sample to stand under a high-temperature condition (85° C.) for 24 hours, and after leaving the sample to stand under a high-temperature and high-humidity condition (60% and 95% RH) for 24 hours. The measured results are shown in Table 4.

TABLE 4

| | | | Example | | | | Comparative |
|---|---|---|---|---|---|---|---|
| | | | 9 | 10 | 11 | 12 | Example 6 |
| Mixing proportion | Polyester unsaturated compound *1 | | 100 | 100 | 100 | 100 | 100 |
| (weight part) | Multifunctional | ethyleneglycol•diglycidyl | 1 | 10 | — | — | — |
| | glycidyl monomer | ether *2 | | | | | |
| | | trimethylolpropane•triglycidyl | — | — | 1 | 10 | — |
| | | ether *3 | | | | | |

| | | | | | |
|---|---|---|---|---|---|
| Organic peroxide *4 | 2 | 2 | 2 | 2 | 2 |
| Compound containing acryloxy group *5 | 5 | 5 | 5 | 5 | 5 |
| Compound containing methacryloxy | 3 | 3 | 3 | 3 | 3 |
| group *6 | | | | | |
| Hydrocarbon resin *7 | 1 | 1 | 1 | 1 | 1 |
| Silane coupling agent *8 | 1 | 1 | 1 | 1 | 1 |
| Conductive particle *9 | 4 | 4 | 4 | 4 | 4 |

| | | | | | | |
|---|---|---|---|---|---|---|
| Adhesion force of | Initial | 1000 | 1100 | 1000 | 1200 | 900 |
| non-conductive film | Ordinary condition (room | 900 | 950 | 950 | 1000 | 800 |
| (gf/cm) | temperature × 24 hr) | | | | | |
| | Heat resistance (85° C. × 24 hr) | 800 | 850 | 850 | 900 | 300 |
| | Wet heat resistance | 750 | 800 | 800 | 850 | 350 |
| | (60° C., 95% RH × 24 hr) | | | | | |

*1: decomposition compound of saturated copolymer polyester “elitel UE3600”, made by Unitika Ltd., into which is introduced methacryloxy group (number average molecular weight of 3000)
*2: “40E” made by Kyoeisha Chemical Co., Ltd.
*3: “100MF” made by Kyoeisha Chemical Co., Ltd.
*4: benzoylperoxide
*5: pentaeryethtol tetraacrylate
*6: neopentylglycol dimethacrylate
*7: hydrocarbon resin “ARKON P70” made by Arakawa Chemical Industries Ltd.
*8: γ-methacryloxypropyltrimethoxysilane
*9: gold-plated plastic particles with average particle size of 5 μm, and mixed amount is in terms of volume % with respect to thermosetting resin

As seen from Table 4, the anisotropic conductive film of Comparative Example 6, which does not contain any multifunctional glycidyl monomer, has no serious problem with durability of an adhesion force at room temperature, but it has poor durability against heat and against wet heat. On the other hand, the films of Examples 9-12, which are mixed with the multifunctional glycidyl monomer, have superior durability of an adhesion force against heat and against wet heat.

### Preferred Embodiments of Third and Fourth Aspects

The adhesive agent composition and the film for an electronic component, according to the third and fourth aspects, contain a thermosetting resin and a multifunctional glycidyl monomer. The adhesive agent is able to maintain a high adhesive force over a long period even under conditions requiring resistance against heat and resistance against wet heat.

The thermosetting resin may be a polyacetal resin obtained by acetalizing polyvinyl alcohol and/or a modified polyacetal resin obtained by introducing an aliphatic unsaturated group into a side chain of the polyacetal resin. The thermosetting resin may be a polyester unsaturated compound which is dissoluble in a solvent.

The polyacetal resin preferably contains an acetal group of 30 mol % or more. If the rate of the acetal group is smaller than 30 mol %, moisture resistance may deteriorate. Examples of the polyacetal resin include polyvinyl formal and polyvinyl butyral. In particular, polyvinyl butyral is preferable. Practicable examples of the polyacetal resin include “DENKA PVB3000-1” and “DENKA PVB2000-L” made by Denki Kagaku Kogyo K.K.

The modified polyacetal resin is also preferably modified polyvinyl butyral.

The polyvinyl butyral resin is made up of, as shown in the following formula (1), a vinyl butyral unit A, a vinyl alcohol unit B, and a vinyl acetate unit C. The aliphatic unsaturated group may be introduced to a side chain of any of those units A, B and C, but it is preferably introduced to a side chain of the vinyl alcohol unit B. The aliphatic unsaturated group is preferably, for example, a vinyl group, an allyl group, a methacrylic group, or an acrylic group.

When the aliphatic unsaturated group is introduced to a side chain of the polyvinyl alcohol unit B, it is preferably introduced by acid-modifying a hydroxyl group in that side chain. An acid used in the acid modification may be an acrylic acid, a methacrylic acid, a stearic acid, a maleic acid, or a phthalic acid. An aliphatic unsaturated bond is introduced as shown in the following formula (2).

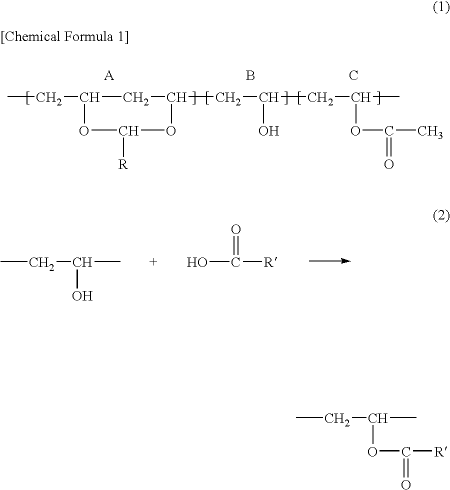

wherein R is a hydrogen atom or an alkyl group, and R′ is an aliphatic unsaturated group, e.g., an alkenyl group, or a group containing the aliphatic unsaturated group.

In the above formula (1), the vinyl alcohol unit B is preferably 3-70 mol %, more preferably 5-50 mol %, and even more preferably 5-30 mol %. If the vinyl alcohol unit B is less than 3 mol %, reactivity of the acid modification is poor, and if it is more than 70 mol %, heat resistance and moisture resistance may deteriorate.

As described above, the thermosetting resin may be the polyester unsaturated compound that is dissoluble in an organic solvent, such as acetone, MEK, toluene, xylene, ethyl acetate, cellosolve acetate, dioxane, THF, benzene, cyclohexane, and Solvesso 100. The polyester unsaturated compound may be unsaturated polyester which is obtained by reacting a polybasic acid and a polyhydric alcohol with each other. Alternatively, the polyester unsaturated compound may be a compound obtained by introducing a (metha)acryloxy group into saturated copolymer polyester that is dissolved in a solvent. The (metha)acryloxy group is an acryloxy group and/or a metha-acryloxy group.

The saturated copolymer polyester dissoluble in the solvent is obtained by copolymerization of acid and alcohol. The acid preferably contains a terephthalic acid. Further, the acid contains a phthalic acid, an isophthalic acid, an adipic acid, a sebacic acid, a dodecane acid, etc. in amount of 5-50 mol % with respect to the total amount of the acid. The alcohol preferably contains ethylene glycol and/or 1,4-butanediol. Further, the alcohol contains at least one kind of 1,3-propanediol, 2,2-dimethyl-1,3-propanediol, 2,2-diethyl-1,3-propanediol, 2-ethyl-2-butyl-1,3-propanediol, 1,6-hexanediol, 1,9-nonanediol, etc. in amount of 5-50 mol % with respect to the total amount of the alcohol.

The (metha)acryloxy group is introduced into the saturated copolymer polyester by the following method (1), (2) or (3).
(1) A method of reacting isocyanatealkyl(metha)acrylate with a hydroxyl group of the saturated copolymer polyester.
(2) A method of utilizing an ester interchange reaction between alkyl(metha)acrylate and a hydroxyl group of the saturated copolymer polyester.
(3) A method of reacting isocyanatealkyl(metha)acrylate, which is obtained by a reaction between a diisocyanate compound and hydroxyalkyl(metha)acrylate, with a hydroxyl group of the saturated copolymer polyester.

The thermosetting resin contains an organic peroxide as a hardener. The organic peroxide is decomposed at temperature of 70° C. or above to generate a radical. Preferably, the decomposition temperature of the organic peroxide at a half-life of 10 hours is 50° or above.

The organic peroxide may be at least one kind of 2,5-dimethy-2,5-di(benzoylperoxy)hexane, 2,5-dihydroperoxide, 2,5-dimethyl-2,5-di(t-butylperoxy)hexine3, di-t-butylperoxide, t-butylcumylperoxide, 2,5-dimethyl-2,5-di(t-butylperoxy)hexane, dicumylperoxide, α,α′-bis(t-butylperoxyisopropyl)benzene, n-butyl-4,4′-bis(t-butylperoxy)valerate, 1,1-bis(t-butylperoxy)cyclohexane, 1,1-bis(t-butylperoxy)-3,3,5-trimethylcyclohexane, t-butyl peroxybenzoate, benzoyl peroxide, t-butylperoxy acetate, methyl ethyl ketone peroxide, 2,5-dimethylhexyl-2,5-bisperoxybenzoate, butyl hydroperoxide, p-menthane hydroperoxide, p-chlorobenzoyl peroxide, hydroxyheptyl peroxide, chlorohexanone peroxide, octanoyl peroxide, decanoyl peroxide, rauloyl peroxide, cumylperoxyoctoate, succinic acid peroxide, acetyl peroxide, t-butylperoxy(2-ethylhexanoate), m-toluoyl peroxide, t-butylperoxyisobutylate, and 2,4-dichlorobenzoyl peroxide.

The organic peroxide is mixed in amount of preferably 0.1-10 weight parts with respect to 100 weight parts of the thermosetting resin.

For the purpose of increasing durability of an adhesion force against heat and against wet heat, the adhesive agent composition contains a multifunctional glycidyl monomer. The multifunctional glycidyl monomer contains two or more glycidyl groups in a molecule in average.

The compound having two glycidyl groups in a molecule in average may be, for example, polyethyleneglycol•diglycidyl ether, polypropyleneglycol•diglycidyl ether, tetramethyleneglycol•diglycidyl ether, 1,6-hexamethyleneglycol•diglycidyl ether, neopentylglycol•diglycidyl ether, or glycerin•diglycidyl ether, which belong to the aliphatic series; hydrogenated bisphenol A•diglycidyl ether, hydrogenated isophthalic acid diglycidyl ester, 3,4-epoxy•cyclohexyl•methyl-3,4-epoxy•cyclohexane•carboxylate, or bis(3,4-epoxy•cyclohexyl)adipate, which belong to the alicyclic series; diglycidyl-hydantoin, diglycidyl•oxyalkyl•hydantoin, which belong to the heterocyclic series; or bisphenol A•diglycidyl ether, an initial condensation product of bisphenol A•diglycidyl ether, diphenylmethane diglycidyl ether, terephthalic acid diglycidyl ester, isophthalic acid diglycidyl ester, or diglycidyl•aniline, which belong to the aromatic series.

The compound having three glycidyl groups in a molecule in average may be, for example, trimethylolpropane•triglycidyl ether which belongs to the aliphatic series; triglycidyl isocyanurate, triglycidyl cyanurate, or triglycidyl•hydantoin, which belong to the heterocyclic series; or triglycidyl-para- or meta-aminophenol which belongs to the aromatic series.

The compound having four glycidyl groups in a molecule in average may be, for example, tetraglycidyl•benzylethane, sorbitol•tetraglycidyl ether, tetraglycidyl•diaminophenylmethane, or tetraglycidyl•bisaminomethylcyclohexane.

The multifunctional glycidyl monomer is preferably at least one kind of multifunctional glycidyl ether compound. It may be, for example, ethyleneglycol•diglycidyl ether or trimethylolpropane•triglycidyl ether. Most preferably, it is trimethylolpropane•triglycidyl ether.

If the amount of the mixed multifunctional glycidyl monomer is too small, the effect of increasing durability against heat and against wet heat with the mixing of the multifunctional glycidyl monomer cannot be obtained at a sufficient level. If it is too large, the amounts of the other ingredients are relatively reduced, thus resulting in a risk that the inherent adhesivity may be deteriorated. The amount of the mixed multifunctional glycidyl monomer is preferably 0.1-20 weight parts, more preferably 1-10 weight parts, with respect to 100 weight parts of the thermosetting resin.

At least one kind of melamine-based resins and alkyd resins may be mixed for the purpose of increasing the adhesivity.

The melamine-based resin may be at least one kind of a melamine resin, a butylated melamine resin such as an isobutylated melamine resin and an n-butylated melamine resin, and a methylated melamine resin. The melamine-based resin is mixed in amount of preferably 1-200 weight parts, more preferably 1-100 weight parts, with respect to 100 weight parts of the thermosetting resin.

The alkyd resin may be any of a pure alkyd resin and a modified alkyd resin, but it is preferably oil-free, or a short- or medium-oil resin. The alkyd resin is mixed in amount of preferably 0.01-10 weight parts, more preferably 0.5-5 weight parts, with respect to 100 weight parts of the thermosetting resin.

A urine-based resin may be mixed in the adhesive agent composition to prevent bubbles from intruding into the adhesive layer, thereby ensuring even higher conductivity and an even larger adhesion force. The urine-based resin may be, for example, a urine resin or a butylated urine-based resin. Additionally, a phenol resin, a butylated benzoguanamine resin, an epoxy resin, etc. may also be mixed for the same purpose.

The resin added for preventing intrusion of bubbles, e.g., the urine-based resin, is mixed in amount of preferably 0.01-10 weight parts, more preferably 0.5-5 weight parts, with respect to 100 weight parts of the adhesive agent composition.

At least one kind of reactive compound (monomer) having an acryloxy group, a methacryloxy group, or an epoxy group is preferably mixed in the adhesive agent composition for the purpose of improving or adjusting mechanical strength, adhesivity, optical characteristics, heat resistance, moisture resistance, weatherability, a cross-linking rate, etc. The reactive compound may be a derivative of an acrylic acid or a methacrylic acid, e.g., any of esters and amides thereof. The ester residue may be, for example, not only an alkyl group such as a methyl, ethyl, dodecyl, stearyl, or layryl group, but also a cyclohexyl group, a tetrahydrofurfuryl group, an aminoethyl group, a 2-hydroxyethyl group, a 3-hydroxypropyl group, or a 3-chloro-2-hydroxypropyl group. The reactive compound may be ester in combination with a multifunctional alcohol, such as ethylene glycol, triethylene glycol, polypropylene glycol, polyethylene glycol, trimethylol propane, or pentaerythritol. The amide may be diacetone acrylamide.

A multifunctional cross-linking aid may be, for example, ester of an acrylic acid or a methacrylic acid, such as trimethylol propane, pentaerythritol, or glycerine. The compound containing the epoxy group may be triglycidyl tris(2-hydroxyethyl)isocyanurate, neopentyl glycol diglycidyl ether, 1,6-hexandiol diglycidyl ether, allyl glycidyl ether, 2-ethylhexyl glycidyl ether, phenyl glycidyl ether, phenol(EO)₅ glycidyl ether, p-t-butylphenyl glycidyl ether, adipic acid diglycidyl ester, phthalic acid diglycidyl ester, glycidyl methacrylate, or butyl glycidyl ether. The compound containing the epoxy group may be a polymer alloy containing the epoxy group.

The reactive compound is added in amount of 0.5-80 weight parts, preferably 0.5-70 weight parts, with respect to 100 weight parts of the thermosetting resin. If the mixed amount exceeds 80 weight parts, workability and film formation performance in the stage of preparing the adhesive agent may be reduced.

The adhesive agent composition is preferably added with a silane coupling agent as an adhesion accelerator. The silane coupling agent may be at least one kind of vinyltriethoxysilane, vinyltris(β-methoxyethoxy)silane, γ-methacryloxypropyltrimethoxysilane, vinyltriacetoxysilane, γ-glycidoxypropyltrimethoxysilane, γ-glycidoxypropyltriethoxysilane, β-(3,4-epoxycyclohexyl)ethyltrimethoxysilane, vinyltrichlorosilane, γ-mercaptopropyltrimethoxysilane, γ-aminopropyltriethoxysilane, and N-β-(aminoethyl)-γ-aminopropyltrimethoxysilane.

The amount of the added silane coupling agent is sufficient at 0.01-5 weight parts with respect to 100 weight parts of the thermosetting resin.

The adhesive agent composition may contain a hydrocarbon resin for the purpose of improving workability, sticking properties, etc. The added hydrocarbon resin may be any of natural resins and synthetic resins. As the natural resins, rosin, a rosin derivative, and a terpen-based resin are preferably used. Practicable examples of the rosin include a gum-based resin, a tall oil-based resin, and a woody resin. Practicable examples of the rosin derivative are obtained by hydrogenating, de-homogenizing, polymerizing, esterifying, or metal-chloridizing the rosin. The terpen resin may be any of terpen-based resins such as α-pinene and βP-pinene, or a terpen phenol resin. Other examples of the natural resins include dammar, copal, and shellac. As the synthetic resins, petroleum-based resins, phenol-based resins, and xylene-based resins are preferably used. Practicable examples of the petroleum-based resins include aliphatic petroleum resins, aromatic petroleum resins, alicyclic petroleum resins, copolymeric petroleum resins, hydrogenated petroleum resins, pure monomeric petroleum resins, and a coumarone-indene resin. Practicable examples of the phenol-based resins include an alkylphenol resin and a modified phenol resin. Practicable examples of the xylene-based resins include a xylene resin and a modified xylene resin.

The amount of the added hydrocarbon resin is preferably 1-200 weight parts, more preferably 5-150 weight parts, with respect to 100 weight parts of the thermosetting resin.

The adhesive agent composition may contain conductive particles. The conductive particles may be, for example, powder of a metal or an alloy including copper, silver, nickel, etc., or resin or ceramic powder coated with such a metal or alloy. The particles may have any desired shape including scale-like, dendritic, granular, and pellet-like shapes.

The conductive particles preferably have the elastic modulus of 1.0×10⁷-1.0×10¹⁰ Pa. The adhesive film containing the conductive particles, which has the elastic modulus in such a range, is able to suppress springback after the bonding. The conductive particles are preferably formed of synthetic resin particles of which surfaces are coated with the above-mentioned metal or alloy.

The amount of the mixed conductive particles is preferably 0.1-15 volume % of the adhesive agent resin composition. The average particle size of the conductive particles is preferably 0.1-100 μm.

In addition to the above-mentioned additives, the adhesive agent composition may contain an antiaging agent, an ultraviolet absorber, a dye, a working aid, etc. within a range not impairing the object of the present invention.

The adhesive agent composition containing the conductive particles has preferably a melt-in index (MFR) of preferably 1-3000, more preferably 1-1000, and even more preferably 1-800. Also, the flowability of that adhesive agent composition at 70° C. is preferably not more than 10⁵ Pa·s. Accordingly, the mixing proportion is desirably selected so that the MFR and the flowability are obtained in those ranges.

The film is produced through the steps of kneading the adhesive agent composition by an extruder, rolls, etc., and then forming it into a film with a predetermined shape by a film formation method utilizing a calender roll, T-die extrusion, or inflation. The adhesive film may also be formed through the steps of dissolving or dispersing the adhesive agent composition in a solvent, coating the solution over the surface of a separator, and evaporating the solvent. When the adhesive film is formed, the film may be embossed, for example, in order to prevent blocking and to facilitate press-bonding to a bonding target.

Bonding targets can be bonded to each other through the film by various methods, e.g., a sticking method using a heat press, a direct lamination method using an extruder or a calender, a thermal press bonding method using a film laminator.

The adhesive agent composition is hardened preferably at 70-170° C., more preferably at 70-150° C., for a period of preferably 10 seconds-120 minutes, more preferably 20 seconds-60 minutes.

In the bonding step, pressure of about 1-4 MPa, in particular about 2-3 MPa, may be applied in the bonding direction.

When the adhesive film contains conductive particles, film conductivity is preferably not larger than 10Ω, more preferably not larger than 5Ω, in the direction of film thickness, and film resistance in the plane direction is preferably not smaller than 10⁶Ω, more preferably not smaller than 10⁹Ω.

The film formed from the adhesive agent composition is preferably used for connection between an FPC board or a TAB chip and ITO terminals formed on a glass substrate of a liquid crystal panel, but it can also be used in other various applications. Since a cross-linked structure is formed when the adhesive agent composition is hardened, high adhesivity and superior durability of an adhesion force against heat and against wet heat can be obtained.

### EXAMPLES ACCORDING TO THIRD AND FOURTH ASPECTS AND COMPARATIVE EXAMPLE

### Examples 13-16 and Comparative Example 7

A toluene 25-weight % solution of polyvinyl butyral (“DENKA PVB3000-1” made by Denki Kagaku Kogyo K.K.) was prepared. Other ingredients shown in Table 5 were mixed in amounts, shown in Table 5, with respect to 100 weight parts of the polyvinyl butyral as a base resin. The mixture was coated over a separator made of ethylene polyterephthalate by using a bar coater. By evaporating toluene, a film with a width of 5 mm and a thickness of 15 μm was obtained.

After peeling off the separator, the obtained film was properly positioned by using a monitor for bonding between a glass substrate and a polyimide substrate. Then, both the substrates were subjected to thermal press bonding at 170° C. and 3 MPa for 15 seconds.

The thus-obtained film was measured for an adhesion force by a 90°-peeling test (50 mm/min) using a tensile tester immediately after the thermal press bonding (initial), after leaving the film to stand under an ordinary condition (room temperature) for 24 hours, after leaving the film to stand under a high-temperature condition (85° C.) for 24 hours, and after leaving the film to stand under a high-temperature and high-humidity condition (60% and 95% RH) for 24 hours. The measured results are shown in Table 5.

TABLE 5

| | | | Example | | | | Comparative |
|---|---|---|---|---|---|---|---|
| | | | 13 | 14 | 15 | 16 | Example 7 |
| Mixing proportion | Thermosetting resin (polyvinyl butyral) | | 100 | 100 | 100 | 100 | 100 |
| (weight part) | Organic peroxide *1 | | 2 | 2 | 2 | 2 | 2 |
| | Multifunctional | ethyleneglycol•diglycidyl | 1 | 10 | — | — | — |
| | glycidyl monomer | ether *2 | | | | | |
| | | trimethylolpropane•triglycidyl | — | — | 1 | 10 | — |
| | | ether *3 | | | | | |

| | | | | | |
|---|---|---|---|---|---|
| Silane coupling agent *4 | 0.5 | 0.5 | 0.5 | 0.5 | 0.5 |
| Conductive particle *5 | 4 | 4 | 4 | 4 | 4 |

| | | | | | | |
|---|---|---|---|---|---|---|
| Adhesion force of | Initial | 800 | 800 | 800 | 800 | 792 |
| anisotropic | Ordinary condition (room | 721 | 732 | 699 | 710 | 700 |
| conductive film | temperature × 24 hr) | | | | | |
| (gf/cm) | Heat resistance (85° C. × 24 hr) | 449 | 646 | 409 | 654 | 276 |
| | Wet heat resistance | 496 | 548 | 516 | 620 | 377 |
| | (60° C., 95% RH × 24 hr) | | | | | |

*1: “DENKA PVB3000-1” made by Denki Kagaku Kogyo K.K.
*2: “40E” made by Kyoeisha Chemical Co., Ltd.
*3: “100MF” made by Kyoeisha Chemical Co., Ltd.
*4: γ-methacryloxypropyltrimethoxysilane
*5: gold-plated plastic particles with average particle size of 5 μm, and mixed amount is in terms of volume % with respect to thermosetting resin

As seen from the results of Table 5, the film of Comparative Example 7, which does not contain any multifunctional glycidyl monomer, has no serious problem with durability of an adhesion force at room temperature, but it has poor durability against heat and against wet heat. On the other hand, the films of Examples 13-16, which are mixed with the multifunctional glycidyl monomer, have superior durability of an adhesion force against heat and against wet heat.

1. An adhesive agent composition for an electronic component, said adhesive agent composition containing a thermosetting compound and used for bonding said electronic component, wherein said thermosetting compound is a polyester unsaturated compound having a number average molecular weight of 2,000-6,000.

2. The adhesive agent composition according to claim 1, wherein said polyester unsaturated compound is a compound obtained by introducing an acryloxy group and/or a methacryoxy group into saturated copolymer polyester.

3. The adhesive agent composition according to claim 1, further containing a multifunctional glycidyl monomer.

4. The adhesive agent composition according to claim 3, wherein the content of said multifunctional glycidyl monomer is 0.1-20 weight parts with respect to 100 weight parts of said polyester unsaturated compound.

5. The adhesive agent composition according to claim 3, wherein said multifunctional glycidyl monomer is a compound belonging to multifunctional glycidyl ethers.

6. The adhesive agent composition according to claim 4, wherein said multifunctional glycidyl monomer is ethyleneglycol•diglycidyl ether and/or trimethylolpropane•triglycidyl ether.

7. The adhesive agent composition according to claim 1, further containing 0.1-10 weight parts of an organic peroxide with respect to 100 weight parts of said thermosetting compound.

8. The adhesive agent composition according to claim 1, further containing 0.5-80 weight parts of at least one kind of a reactive compound, which is selected from among a group consisting of a compound containing an acryloxy group, a compound containing a methacryoxy group, and a compound containing an epoxy group, with respect to 100 weight parts of said adhesive agent resin component.

9. The adhesive agent composition according to claim 1, further containing 0.01-5 weight parts of a silane coupling agent with respect to 100 weight parts of said adhesive agent resin component.

10. The adhesive agent composition according to claim 1, further containing 1-200 weight parts of a hydrocarbon resin with respect to 100 weight parts of said adhesive agent resin component.

11. The adhesive agent composition according to claim 1, further containing conductive particles.

12. The adhesive agent composition according to claim 11, wherein said conductive particles are mixed in amount of 0.1-15 volume % with respect to said adhesive agent resin component.

13. A electronic component adhesive film for bonding an electronic component, wherein said adhesive film is produced by forming the adhesive agent composition according to claim 1 into a film.

14. An adhesive agent composition containing a thermosetting compound and used for bonding an electronic component, wherein said adhesive agent composition further contains a multifunctional glycidyl monomer.

15. The adhesive agent composition according to claim 14, wherein the content of said multifunctional glycidyl monomer is 0.1-20 weight parts with respect to 100 weight parts of thermoplastic resin.

16. The adhesive agent composition according to claim 14, wherein said multifunctional glycidyl monomer is a compound belonging to multifunctional glycidyl ethers.

17. The adhesive agent composition according to claim 14, wherein said multifunctional glycidyl monomer is ethyleneglycol•diglycidyl ether and/or trimethylolpropane•triglycidyl ether.

18. The adhesive agent composition according to any one of claim 14, further containing 0.1-10 weight parts of an organic peroxide with respect to 100 weight parts of said thermoplastic resin.

19. The adhesive agent composition according to claim 14, wherein said thermoplastic resin is a polyacetal resin obtained by acetalizing polyvinyl alcohol and/or a modified polyacetal resin obtained by introducing an aliphatic unsaturated group into a side chain of the polyacetal resin.

20. The adhesive agent composition for the electronic compound according to claim 14, wherein said thermoplastic resin is a polyester unsaturated compound.

21. The adhesive agent composition according to claim 14, further containing 0.5-80 weight parts of at least one kind selected from among a group consisting of a compound containing an acryloxy group, a compound containing a methacryoxy group, and a compound containing an epoxy group with respect to 100 weight parts of said thermoplastic resin.

22. The adhesive agent composition according to claim 14, further containing 0.01-5 weight parts of a silane coupling agent with respect to 100 weight parts of said thermoplastic resin.

23. The adhesive agent composition according to claim 14, further containing 1-200 weight parts of a hydrocarbon resin with respect to 100 weight parts of said thermoplastic resin.

24. The adhesive agent composition according to claim 14, further containing conductive particles.

25. The adhesive agent composition for the electronic component according to claim 24, wherein said conductive particles are mixed in amount of 0.1-15 volume % with respect to said adhesive agent resin component.

26. An adhesive film wherein said adhesive film is produced by forming the adhesive agent composition according to claim 14 into a film.

27. Use of the adhesive film according to claim 13, wherein an electronic component is bonded by using said film.

28. Use of the adhesive film according to claim 26, wherein an electronic component is bonded by using said film.
